(19) United States
(12) Patent Application Publication
(10) Pub. No.: US 2009/0279513 A1
(43) Pub. Date: Nov. 12, 2009

(54) METHOD FOR TRANSMITTING SIGNAL AND METHOD FOR RECEIVING SIGNAL

(75) Inventors: Kap-Seok Chang, Daejeon (KR); Il-Gyu Kim, Daejeon (KR); Hyeong-Geun Park, Daejeon (KR); Young-Jo Ko, Daejeon (KR); Young-Hoon Kim, Daejeon (KR); Seung-Chan Bang, Daejeon (KR)

Correspondence Address: CANTOR COLBURN, LLP, 20 Church Street, 22nd Floor, Hartford, CT, 06103, US

(73) Assignee: ELECTRONICS AND TELECOMMUNICATIONS RESEARCH INSTIT, Daejeon (KR)

(21) Appl. No.: 12/306,058

(22) PCT Filed: Jun. 21, 2007
(86) PCT No.: PCT/KR2007/003028

§ 371 Date: Dec. 22, 2008

(30) Foreign Application Priority Data
Jun. 21, 2006 (KR) 10-2006-0055918
Jul. 3, 2006 (KR) 10-2006-0061902
Aug. 31, 2006 (KR) 10-2006-0083772

(51) Int. Cl. H04J 3/06

(52) U.S. Cl. 370/336

(57) ABSTRACT

A sector transmitter maps a synchronization channel and a broadcast channel to be on a time axis adjacent to each other, and applies the same bandwidth and the same transmission diversity to the synchronization channel and the broadcast channel. A mobile station estimates a plurality of channel statuses for a plurality of sectors from a synchronization channel signal, and acquires broadcast channel information from a broadcast channel signal using the plurality of estimated channel statuses. As a result, the mobile station can receive a broadcast channel with high reception quality while having low complexity.

### TECHNICAL FIELD

The present invention relates to a method of transmitting a signal and a method of receiving a signal.

### BACKGROUND ART

A mobile station needs to efficiently receive BCH information at an initial access stage while supporting an OFDM-based system bandwidth ranging from 1.25 MHz to 20 MHz. Further, the mobile station needs to receive the BCH information with reception quality of a reference value or more.

However, as the reception quality of the BCH information increases, complexity of the mobile station increases.

### DISCLOSURE

### Technical Problem

The present invention has been made in an effort to provide a method of transmitting a signal and a method of receiving a signal, having advantages of reducing the complexity of a mobile station and increasing the reception quality of BCH information.

### Technical Solution

An exemplary embodiment of the present invention provides a method of transmitting a signal, the method including mapping a plurality of synchronization channel symbols and a plurality of broadcast channel symbols to a downlink frame to be on a time axis adjacent to each other, and transmitting the downlink frame.

The mapping to the downlink frame may comprise allocating a first bandwidth to the plurality of synchronization channel symbols, and allocating the first bandwidth to the plurality of broadcast channel symbols.

The method may further include allocating a first antenna to each of the plurality of synchronization channel symbols, and allocating the first antenna to broadcast channel symbols that are on the time axis adjacent to each of the plurality of synchronization channel symbols.

The method may further comprise allocating a plurality of antennas to the plurality of synchronization channel symbols, and allocating the antennas which are allocated to each of the plurality of synchronization channel symbols, to broadcast channel symbols that are on the time axis adjacent to each of the plurality of synchronization channel symbols.

Another exemplary embodiment of the present invention provides a method of transmitting a signal, the method including allocating a plurality of time intervals to a plurality of synchronization channel symbol groups, allocating a plurality of adjacent time intervals that are on a time axis adjacent to each of the plurality of time intervals to a plurality of broadcast channel symbol groups, and transmitting the plurality of synchronization channel symbol groups and the plurality of broadcast channel symbol groups.

The method may further include allocating a plurality of antennas to the plurality of time intervals, and allocating the plurality of antennas to the plurality of adjacent time intervals such that an antenna allocated to each of the plurality of time intervals and an antenna allocated to the adjacent time intervals of each of the plurality of time intervals are the same.

Still another exemplary embodiment of the present invention provides a method of receiving a signal, the method including receiving a synchronization channel signal, estimating a plurality of channel statuses for a plurality of sectors from the synchronization channel signal, receiving a broadcast channel signal having information common to sectors in the same base station, and acquiring broadcast channel information from the broadcast channel signal using the plurality of channel statuses.

Yet still another exemplary embodiment of the present invention provides a method of receiving a signal that allows a mobile station to receive a signal from a base station, which controls a plurality of sectors. The method includes receiving a downlink signal, extracting a synchronization channel signal from the downlink signal, extracting a broadcast channel signal from the downlink signal, confirming at least one sector, which affects the mobile station, among the plurality of sectors from the synchronization channel signal, estimating a channel status for at least one sector from the synchronization channel signal, and demodulating the broadcast channel signal using the channel status for at least one sector.

The demodulating of the broadcast channel signal may include demodulating the broadcast channel signal using a code value for at least one sector and a scrambling code for at least one sector.

### DESCRIPTION OF DRAWINGS

FIG. 1 is a diagram showing a communication system according to an exemplary embodiment of the present invention.

FIG. 2 is a diagram showing a base station according to an exemplary embodiment of the present invention.

FIG. 3 is a block diagram showing a sector transmitter according to an exemplary embodiment of the present invention.

FIG. 4 is a flowchart illustrating a method of transmitting a sector according to an exemplary embodiment of the present invention.

FIG. 5 shows bandwidth allocation to SCH and BCH according to an exemplary embodiment of the present invention.

FIG. 6 shows bandwidth allocation to SCH and BCH according to another exemplary embodiment of the present invention.

FIGS. 7 to 10 show downlink frames, to which the SCH and BCH are mapped, according to various exemplary embodiments of the present invention.

FIGS. 11 to 13 show downlink frames, to which an SCH symbol and a BCH symbol are mapped, according to various exemplary embodiments of the present invention.

FIG. 14 is a block diagram showing a sector transmitter according to another exemplary embodiment of the present invention.

FIG. 15 is a flowchart illustrating a method of transmitting a sector, to which TSTD is applied, according to another exemplary embodiment of the present invention.

FIG. 16 is a block diagram showing a signal receiving apparatus according to an exemplary embodiment of the present invention.

FIG. 17 is a flowchart showing a method of receiving a signal according to an exemplary embodiment of the present invention.

FIG. 18 is a block diagram showing a signal receiving apparatus according to an exemplary embodiment of the present invention.

FIG. 19 is a flowchart illustrating a method of receiving a signal according to another exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising” will be understood to imply the inclusion of stated elements but not the exclusion of any other elements.

As used in this application, a mobile station (MS) may be referred to as, and include some or all the functionality of, a terminal, a mobile terminal (MT), a subscriber station (SS), a portable subscriber station (PSS), a user equipment (UE), an access terminal (AT) or some other terminology.

As used in this application, a base station (BS) may be referred to as, and include some or all the functionality of, an access point (AP), a radio access station (RAS), a node B, a base transceiver station (BTS) or some other terminology.

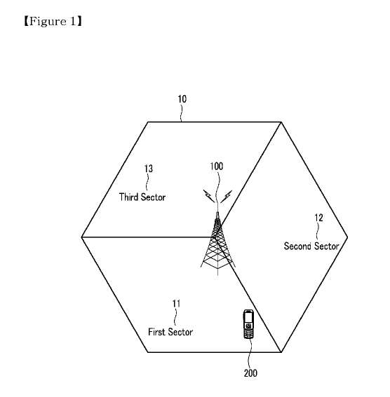

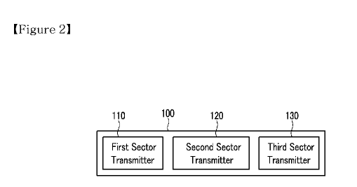

Next, a communication system according to an exemplary embodiment of the present invention will be described with reference to FIGS. 1 and 2.

FIG. 1 is a diagram showing a communication system according to an exemplary embodiment of the present invention. FIG. 2 is a diagram showing a base station according to an exemplary embodiment of the present invention.

As shown in FIG. 1, a communication system includes a base station 100 and a mobile station 200. Further, as shown in FIG. 2, the base station 100 includes a first sector transmitter 110, a second sector transmitter 120, and a third sector transmitter 130.

The base station 100 controls a cell 10. The cell 10 includes a first sector 11, a second sector 12, and a third sector 13. Although a case where the cell 10 includes three sectors is described in the exemplary embodiment of the present invention, the cell 10 may include two or four sectors or more. The base station 100 communicates with the mobile station 200 in the cell 10.

The first sector transmitter 110, the second sector transmitter 120, and the third sector transmitter 130 control the first sector 11, the second sector 12, and the third sector 13, respectively. That is, the first sector transmitter 110 communicates with a mobile station in the first sector 11, the second sector transmitter 120 communicates with a mobile station in the second sector 12, and the third sector transmitter 130 communicates with a mobile station in the third sector 13.

The first sector transmitter 110, the second sector transmitter 120, and the third sector transmitter 130 transmit synchronization channel (SCH) information and broadcast channel (BCH) information to the first sector 11, the second sector 12, and the third sector 13, respectively. The SCH information is different for the individual sectors, and the BCH information is common to all of the sectors. That is, the SCH information is distinguished according to the sectors, and the BCH information is distinguished according to the cells. The BCH information is transmitted through a predefined independent physical channel, which is known to all of the mobile stations 200. The first sector transmitter 110, the second sector transmitter 120, and the third sector transmitter 130 are synchronized with each other such that the mobile station 200 can demodulate the BCH information through soft-combining.

In the exemplary embodiment of the present invention, among a plurality of sectors that constitute the cell 10, a sector in which the mobile station 200 is located is referred to as a home sector. Referring to FIG. 1, the mobile station 200 regards the first sector having the highest reception power among the sectors in the same base station to be the home sector.

Meanwhile, the mobile station 200 is close to the second sector. Accordingly, the mobile station 200 can receive, with reception power of a threshold value or more, a signal that the second sector transmitter 120 transmits. As such, among the plurality of sectors that constitute the cell 10, excluding the home sector, a sector that affects the mobile station 200 is referred to as a target sector.

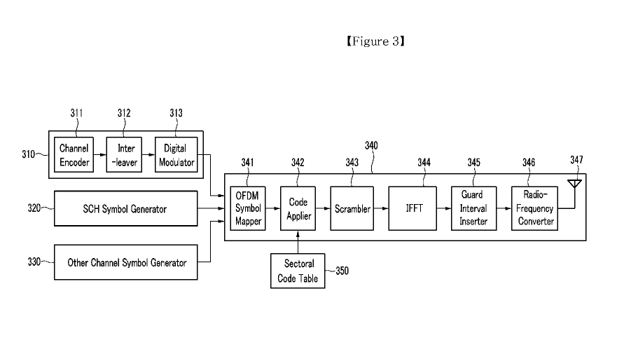

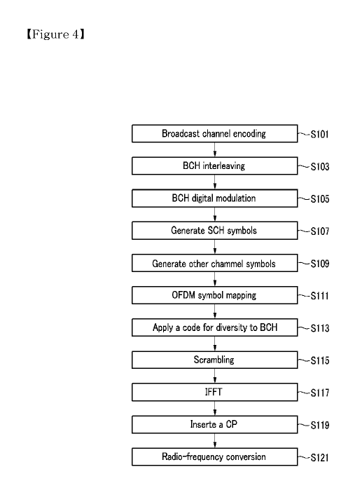

Next, a sector transmitter according to an exemplary embodiment of the present invention will be described with reference to FIGS. 3 and 4.

FIG. 3 is a block diagram showing a sector transmitter according to an exemplary embodiment of the present invention.

As shown in FIG. 3, a sector transmitter 300 according to an exemplary embodiment of the present invention transmits a signal to an s-th sector. The sector transmitter 300 includes a BCH symbol generator 310, an SCH symbol generator 320, an other channel symbol generator 330, and a transmitter 340. The BCH symbol generator 310 includes a channel encoder 311, an interleaver 312, and a digital modulator 313. The transmitter 340 includes an OFDM symbol mapper 341, a code applier 342, a scrambler 343, an inverse Fast Fourier transformer (IFFT) 344, a guard interval inserter 345, a radio-frequency converter 346, an antenna 347, and a sectoral code table 348.

FIG. 4 is a flowchart showing a method of transmitting a sector according to an exemplary embodiment of the present invention.

First, the BCH symbol generator 310 generates and outputs a plurality of BCH symbols.

Specifically, the channel encoder 311 performs channel coding, such as turbo coding or convolution coding, on BCH data, and generates and outputs channel encoded BCH data (Step S101).

The interleaver 312 changes a sequence of the channel encoded BCH data output from the channel encoder 311, and generates and outputs interleaved BCH data (Step S103).

The digital modulator 313 performs digital modulation, such as binary phase shift keying (BPSK) or quadrature amplitude modulation (QAM), on the interleaved BCH data output from the interleaver 312, and generates and outputs a plurality of BCH symbols (Step S105).

Meanwhile, the SCH symbol generator 320 generates and outputs a plurality of SCH symbols (Step S107). When the number of SCH symbols in a subframe in which the SCH exists is N, the SCH symbol generator 320 generates and outputs an SCH symbol vector represented by Equation 1 for the s-th sector.

Aₛ=[A_{0,s}A_{1,s}, . . . , A_{i,s}, . . . , A_{N-1,s}] (Equation 1)

The SCH symbol generator 320 uses an SCH scrambling code represented by Equation 2 in order to generate the SCH symbol vector represented by Equation 1.

aₛ=[a_{0,s}a_{1,s}, . . . , a_{N-1,s}] (Equation 2)

An SCH scrambling code for a subframe in a frame may be different from or identical to an SCH scrambling code for another subframe.

The SCH symbol generator 320 scrambles an SCH symbol uₛ and generates the SCH symbol vector represented by Equation 1 using the SCH scrambling code represented by Equation 2. At this time, an element A_{i,s} of the SCH symbol vector can be obtained through Equation 3. The value of the SCH symbol uₛ may be changed according to the standard. For example, the value of the SCH symbol uₛ may be 1 or (1+j)/\sqrt{2}.

A_{i,s}=μₛ·a_{i,s}, i=0, 1, . . . , N−1 (Equation 3)

The other channel symbol generator 330 generates and outputs a plurality of other channel symbols (Step S109).

The transmitter 340 generates an OFDM symbol using the plurality of BCH symbols output from the BCH symbol generator 310, the plurality of SCH symbols output from the SCH symbol generator 320, and the plurality of other channel symbols output from the other channel symbol generator 330, and transmits the generated OFDM symbol to the s-th sector through the antenna 347.

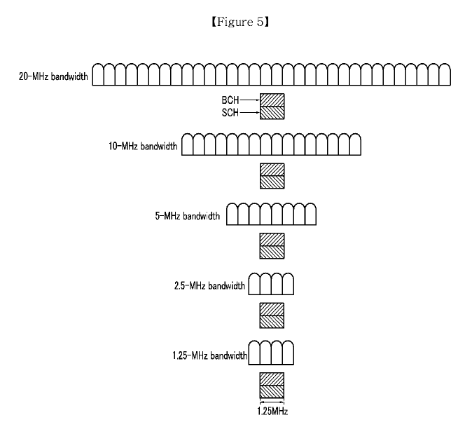

Specifically, the OFDM symbol mapper 341 maps the plurality of BCH symbols, the plurality of SCH symbols, and the plurality of other channel symbols to time and frequency domains, and outputs a plurality of mapped symbols (Step S111). That is, the OFDM symbol mapper 341 performs time division multiplexing and frequency division multiplexing on the plurality of BCH symbols, the plurality of SCH symbols, and the plurality of other channel symbols. A mapping method in the OFDM symbol mapper 341 will be described with reference to FIGS. 5 to 13.

FIG. 5 shows bandwidth allocation to the SCH and BCH according to an exemplary embodiment of the present invention.

As shown in FIG. 5, the sector transmitter 300 can use various bandwidths, such as 1.25 MHz, 2.5 MHz, 5 MHz, 10 MHz, and 20 MHz, as the system bandwidth.

Referring to FIG. 5, the OFDM symbol mapper 341 allocates the plurality of BCH symbols and the plurality of SCH symbols to a medium bandwidth as a common bandwidth of various system bandwidths. Further, the OFDM symbol mapper 341 allocates the same bandwidth as that allocated to the plurality of SCH symbols to the plurality of BCH symbols. Accordingly, the mobile station 200 does not need to perform blind detection on a BCH bandwidth in order to demodulate the BCH symbol.

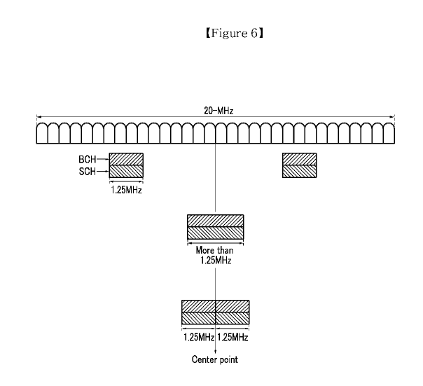

FIG. 6 shows bandwidth allocation to the SCH and BCH according to another exemplary embodiment of the present invention.

As shown in FIG. 6, when the system bandwidth is 20 MHz, the OFDM symbol mapper 341 may allocate a medium bandwidth in a range of plus or minus 10 MHz to the SCH and BCH, or may allocate a medium bandwidth in a range of plus or minus 20 MHz to the SCH and BCH. Further, the OFDM symbol mapper 341 may allocate a bandwidth in a range of plus or minus 1.25 MHz at the middle of the system bandwidth to the SCH and BCH.

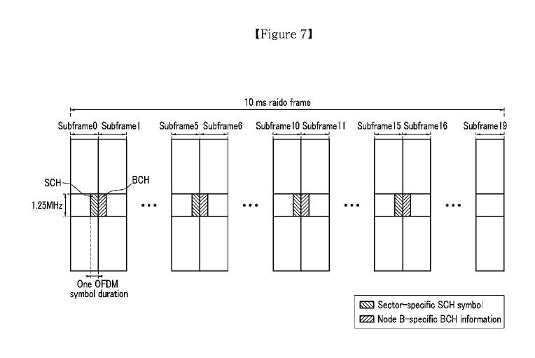

FIGS. 7 to 10 show downlink frames to which the SCH and BCH are mapped according to various exemplary embodiments of the present invention.

As shown in FIGS. 7 to 10, a downlink frame according to an exemplary embodiment of the present invention includes 20 subframes. Further, the SCH and BCH are mapped to a medium bandwidth, 1.25 MHz, of the system bandwidth.

According to the exemplary embodiments shown in FIGS. 7 to 10, the OFDM symbol mapper 341 multiplexes the BCH information into four subframes during a downlink frame period. The BCH information is transmitted to the mobile station 200 in a packet format. A single BCH information packet may be multiplexed in a frame and transmitted for every 10 msec, or may be multiplexed in two or more frames and transmitted for every 20 msec, 30 msec, or 40 msec.

In the exemplary embodiment of the present invention, a multiplexing method that transmits the BCH information through a unicast channel, or a multiplexing method that transmits the BCH information through a multicast channel or an MBMS (Multimedia Broadcast and Multicast Service) channel, can be used.

Referring to FIG. 7, the OFDM symbol mapper 341 maps an SCH symbol to the last OFDM symbol period of each subframe at an interval of five subframes. Next, the OFDM symbol mapper 341 maps a BCH symbol to an OFDM symbol period next to the OFDM symbol period, to which the SCH symbol is mapped.

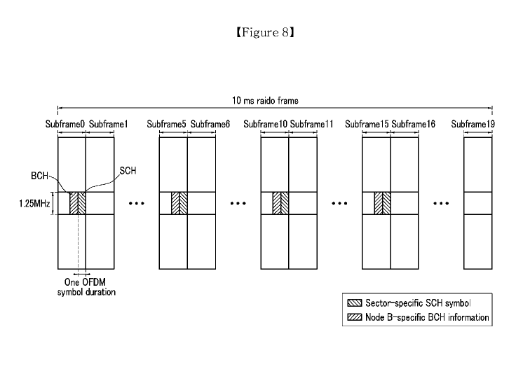

Referring to FIG. 8, the OFDM symbol mapper 341 maps an SCH symbol to a last OFDM symbol period of each subframe at an interval of five subframes. Next, the OFDM symbol mapper 341 maps a BCH symbol to an OFDM symbol period before the OFDM symbol period, to which the SCH symbol is mapped.

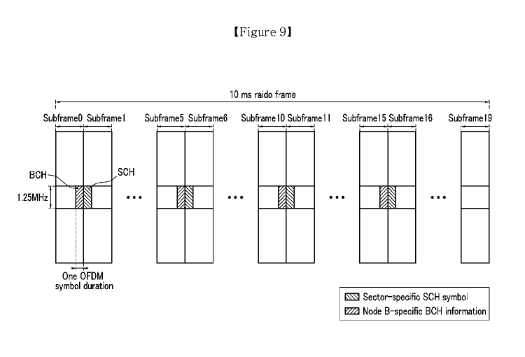

Referring to FIG. 9, the OFDM symbol mapper 341 maps a BCH symbol to the last OFDM symbol period of each subframe at an interval of five subframes. Next, the OFDM symbol mapper 341 maps an SCH symbol to an OFDM symbol period next to the OFDM symbol period, to which the SCH symbol is mapped.

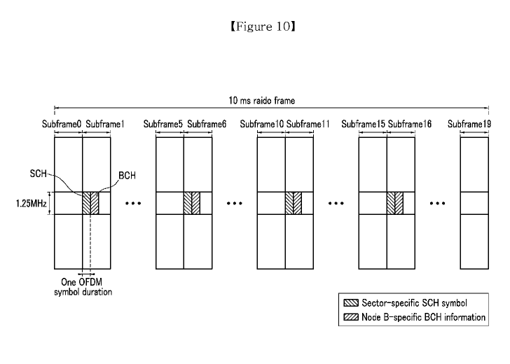

Referring to FIG. 10, the OFDM symbol mapper 341 maps an SCH symbol to the first OFDM symbol period of each subframe at an interval of five subframes. Next, the OFDM symbol mapper 341 maps a BCH symbol to an OFDM symbol period next to the OFDM symbol period, to which the SCH symbol is mapped.

As shown in FIGS. 7 to 10, when the OFDM symbol mapper 341 maps the SCH symbol and the BCH symbol to the downlink frame to be on a time axis adjacent to each other, if the SCH symbol and the BCH symbol are transmitted through the same antenna, the SCH symbol and the BCH symbol are affected by the same channel fading. Accordingly, the mobile station 200 can coherently demodulate the BCH information using SCH estimation information. Meanwhile, performance of channel estimation using a pilot channel, in which a reference signal is disposed at an interval of six subcarriers, is not better than performance of channel estimation using an SCH, in which a synchronization symbol is disposed at an interval of one or two subcarriers.

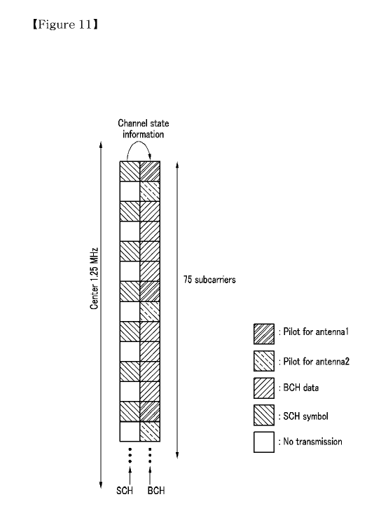

FIG. 11 to FIG. 13 show parts of the downlink frames to which the SCH symbol and the BCH symbol are mapped according to various exemplary embodiments of the present invention.

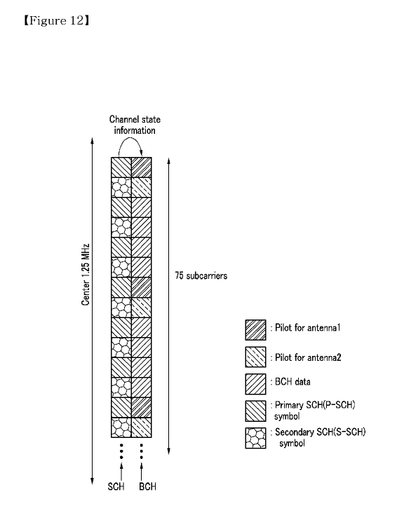

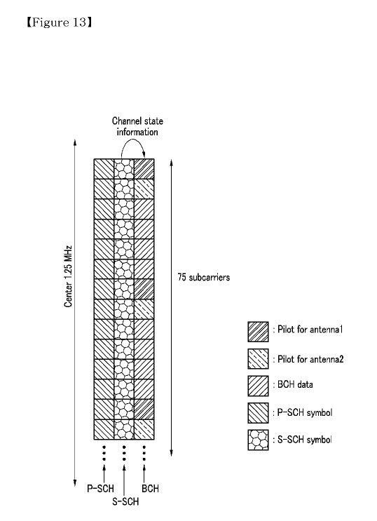

FIG. 11 shows a case where the number of SCH is 1, and FIGS. 12 and 13 show a case where the number of SCH is 2. When the number of SCH is 2, one is referred to as a primary SCH (P-SCH) and the other is referred to as a secondary SCH (S-SCH).

Referring to FIG. 11, the OFDM symbol mapper 341 maps a plurality of SCH symbols at an interval of two subcarriers during one OFDM symbol period.

Referring to FIG. 12, the OFDM symbol mapper 341 allocates a plurality of P-SCH symbols and a plurality of S-SCH symbols to one OFDM symbol period through frequency division multiplexing (FDM). In this case, when a sequence for the P-SCH is common to all of the sectors 11, 12, and 13 and the base station 100, the S-SCH can be used for channel estimation. Further, when 3 or more sequences for the P-SCH exist and the sequences are allocated to the sectors, if different sequences are allocated to adjacent sectors, the P-SCH can also be used for BCH estimation, like the S-SCH.

Referring to FIG. 13, the OFDM symbol mapper 341 allocates a plurality of P-SCH symbols and a plurality of S-SCH symbols to two adjacent OFDM symbol periods by time division multiplexing (TDM). In this case, the S-SCH can be used for channel estimation. Further, as described above, the P-SCH can also be used for channel estimation. When the S-SCH possesses an odd-numbered or even-numbered subcarrier, the mobile station 200 can estimate a channel through the odd-numbered or even-numbered subcarrier. When the S-SCH possesses all of the subcarriers, the mobile station 200 can estimate a channel through all of the subcarriers.

Returning to FIG. 4, the description thereof will be continued.

The code applier 342 applies codes for diversity, which are represented by Equation 4, to mapped BCH symbols among the plurality of mapped symbols output from the OFDM symbol mapper 341 (Step S113).

B_{k,t,a,s}=C_{k,t,a,s}·μₛ·d_{k,t}·p_{k,t,s} (Equation 4)

In Equation 4, k denotes an index of a subcarrier on a BCH symbol, a denotes an index of a transmitting antenna, uₛ denotes a value according to Equation 3, and p_{k,t,s} denotes a sector-specific scrambling code. t denotes a time index at which adjacent SCH symbol and BCH symbol are disposed, as shown in FIGS. 7 to 10. For example, in FIG. 8, t may be 0, 5, 10, or 15. C_{k,t,a,s} denotes a code that is applied to obtain delay diversity or random diversity for BCH information, and d_{k,t} denotes a BCH symbol on a subcarrier k.

In an MIMO (multiple input multiple output) mode, C_{k,t,a,s} can be defined by Equation 5 in order to obtain delay diversity.

$${C}_{k , t , a , s} = {e}^{\pm j \frac{2 π k ( a - 1 ) {Δ}_{s , t}}{{N}_{T}}} , a = 1 , 2 , 3 , … \qquad ( Equation 5 )$$

In Equation 5, N_{T} denotes the size of the IFFT, and Δ_{s,t} denotes the value of cyclic phase rotation allocated to the s-th sector. In order to obtain a high delay diversity gain between the sectors, the value of phase rotation needs to be appropriately adjusted. Further, in order to obtain a random diversity gain, C_{k,t,a,s} can be defined by Equation 6.

C_{k,t,a,s}=ψ(k,t,a,s) (Equation 6)

In Equation 6, ψ(k,t,a,s) denotes a random variable.

Meanwhile, the code applier 342 can apply a complex random code to the mapped BCH symbol for random diversity. The complex random code is different according to the sectors and has a size of 1. The code applier 342 may apply code sequences such that a code sequence allocated to a subcarrier, for example a code sequence represented by Equation 5 or 6, is different from a code sequence allocated to an adjacent subcarrier. Further, the code applier 342 may apply the code sequences such that, while the same code sequence is applied to a plurality of subcarriers in a subcarrier group, a code sequence allocated to a subcarrier group is different from a code sequence allocated to an adjacent subcarrier group. The code applier 342 applies a sectoral code to the mapped BCH symbol according to the sectoral code table 348.

The scrambler 343 scrambles the plurality of mapped symbols output from the code applier 342, excluding the SCH symbols, with the sector-specific scrambling code or the cell-specific scrambling code, and generates and outputs a plurality of scrambled symbols (Step S115). If the SCH symbols are scrambled, an initial cell search may be difficult. Accordingly, the scrambler 343 does not scramble the SCH symbols with the sector-specific scrambling code or the cell-specific scrambling code.

The IFFT 344 performs fast Fourier transform on the plurality of scrambled symbols output from the scrambler 343, and generates and outputs a time-domain signal (Step S117).

The guard interval inserter 345 inserts a guard interval, such as a CP (cyclic prefix), into the time-domain signal output from the IFFT 344, and generates and outputs a guard interval-inserted signal (Step S119).

The radio-frequency converter 346 converts the guard interval-inserted signal output from the guard interval inserter 345 into an intermediate frequency signal and then a radio-frequency signal (Step S121). Subsequently, the radio-frequency converter 346 amplifies the radio-frequency signal and transmits the amplified radio-frequency signal to the mobile station 200 through the antenna 347.

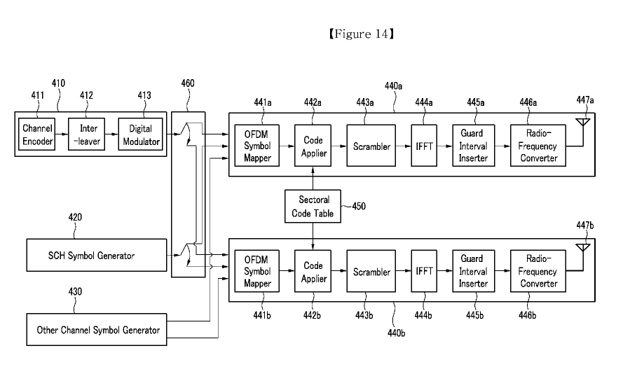

FIG. 14 is a block diagram showing a sector transmitter according to another exemplary embodiment of the present invention.

As shown in FIG. 14, a sector transmitter 400 according to another exemplary embodiment of the present invention, to which time-switched transmit diversity (TSTD) and two transmitting antennas are applied, includes a BCH symbol generator 410, an SCH symbol generator 420, an other channel symbol generator 430, a first transmitter 440a, a second transmitter 440b, a sectoral code table 450, and a switch 460. The BCH symbol generator 410 includes a channel encoder 411, an interleaver 412, and a digital modulator 413. The first transmitter 440a includes a first OFDM symbol mapper 441a, a first code applier 442a, a first scrambler 443a, a first IFFT 444a, a first guard interval inserter 445a, a first radio-frequency converter 446a, and a first antenna 447a. The second transmitter 440b includes a second OFDM symbol mapper 441b, a second code applier 442b, a second scrambler 443b, a second IFFT 444b, a second guard interval inserter 445b, a second radio-frequency converter 446b, and a second antenna 447b.

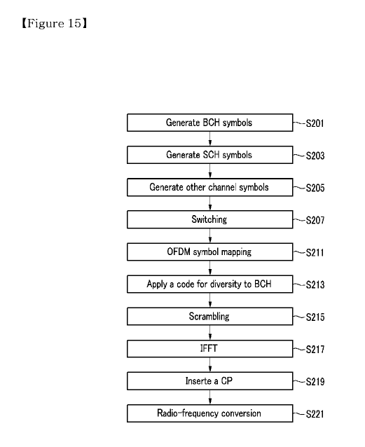

FIG. 15 is a flowchart illustrating a method of transmitting a sector, to which TSTD is applied, according to another exemplary embodiment of the present invention.

In the description of FIG. 15, the same contents as those of FIG. 4 will be omitted.

First, the BCH symbol generator 410 generates a plurality of BCH symbols and outputs the plurality of generated BCH symbols to the switch 460 (Step S201).

Specifically, if the method of transmitting a sector follows FIGS. 7 to 10, the BCH symbol generator 410 outputs a plurality of BCH symbols for each BCH transmission cycle. If a high-order generates a BCH packet for every 10 msec, the BCH symbol generator 410 generates 4M BCH symbols, and outputs the M BCH symbols for every subframe in which the BCH exists.

The SCH symbol generator 420 generates a plurality of SCH symbols and outputs the plurality of generated SCH symbols to the switch 460 (Step S203).

The other channel symbol generator 430 generates and outputs a plurality of other channel symbols (Step S205).

The switch 460 performs switching such that the plurality of BCH symbols and the SCH symbols that are on a time axis adjacent to the plurality of BCH symbols can be transmitted through the same antenna (Step S207). For example, referring to FIG. 8, the switch 460 transmits a BCH symbol and an SCH symbol of a 0-th subframe 0 to the first transmitter 440a, and transmits a BCH symbol and an SCH symbol of a 5-th subframe to the second transmitter 440b. Further, the switch 460 transmits a BCH symbol and an SCH symbol of a 10-th subframe to the first transmitter 440a, and transmits a BCH symbol and an SCH symbol of a 15-th subframe to the second transmitter 440b. In this way, the sector transmitter 400 applies TSTD to the SCH and BCH to reduce a block error rate of the SCH information and BCH information, thereby improving reception quality.

Meanwhile, the switch 460 can apply frequency-switch transmit diversity (FSTD) to the SCH and BCH while performing switching such that the plurality of BCH symbols and the SCH symbols that are on a time axis adjacent to the plurality of BCH symbols can be transmitted through the same antenna. For example, the switch 460 transmits the SCH symbols and the BCH symbols for some subcarriers to the first transmitter 440a, and transmits the SCH symbols and the BCH symbols for other subcarriers to the second transmitter 440b.

The switch 460 may simultaneously apply TSTD and FSTD to the SCH and BCH while performing switching such that the plurality of BCH symbols and the SCH symbols that are on a time axis adjacent to the plurality of BCH symbols can be transmitted through the same antenna.

Meanwhile, unlike the exemplary embodiment of the present invention, when the SCH information and the BCH information are transmitted, the mobile station 200 needs to perform blind detection since it does not have information on the number of antennas that are applied to transmission diversity of the BCH information. That is, the mobile station 200 needs to perform a hypothesis test in order to demodulate the BCH information for the individual cases where the number of antennas is 1, 2, 3, and 4 and to find the highest reception quality. Accordingly, complexity of the mobile station 200 increases. In contrast, like the exemplary embodiment of the present invention, if the SCH information and the BCH information that are on a time axis adjacent to each other are transmitted through the same antenna, the mobile station 200 does not need to perform the blind detection for the number of transmitting antennas of the sector transmitter. Therefore, complexity of the mobile station 200 can be reduced.

The first OFDM symbol mapper 441a and the second OFDM symbol mapper 441b map the plurality of BCH symbols, the plurality of SCH symbols, and the plurality of other channel symbols to time and frequency domains, and output a plurality of mapped symbols (Step S211).

The first code applier 442a and the second code applier 442b apply the codes for diversity, which are represented by Equation 4, to the mapped BCH symbols among the plurality of mapped symbols output from the first OFDM symbol mapper 441a and the second OFDM symbol mapper 441b (Step S213).

The first scrambler 443a and the second scrambler 443b scramble a plurality of symbols, excluding the SCH symbols, the plurality of mapped symbols output from the first code applier 442a and the second code applier 442b, with a sector-specific scrambling code or a cell-specific scrambling code, and generate and output a plurality of scrambled symbols (Step S215).

The first inverse Fourier transformer 444a and the second inverse Fourier transformer 444b perform inverse fast Fourier transform on the plurality of scrambled symbols output from the first scrambler 443a and the second scrambler 443b, and generate and output time-domain signals (Step S217).

The first guard interval inserter 445a and the second guard interval inserter 445b insert a guard interval, such as a CP (cyclic prefix), into the time domain-signals output from the first inverse Fourier transformer 444a and the second inverse Fourier transformer 444b, and generate and output guard interval-inserted signals (Step S219).

The first radio-frequency converter 446a and the second radio-frequency converter 446b convert the guard interval-inserted signals output from the guard interval inserter 445 into intermediate frequency signals and then radio-frequency signals (Step S221). Further, the first radio-frequency converter 446a and the second radio-frequency converter 446b amplify the radio-frequency signals and transmit the amplified radio-frequency signals to the mobile station 200 through the first antenna 447a and the second antenna 447b.

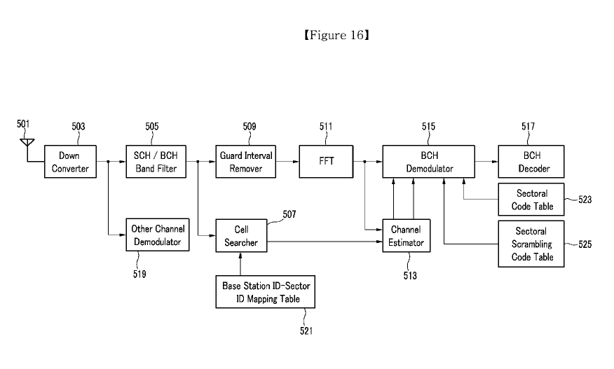

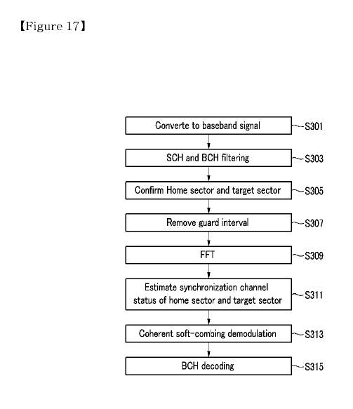

Next, a signal receiving apparatus of the mobile station 200 according to an exemplary embodiment of the present invention will be described with reference to FIGS. 16 and 17.

FIG. 16 is a block diagram showing a signal receiving apparatus according to an exemplary embodiment of the present invention.

As shown in FIG. 16, a signal receiving apparatus 500 according to an exemplary embodiment of the present invention includes an antenna 501, a down transformer 503, an SCH/BCH band filter 505, a cell searcher 507, a guard interval remover 509, a Fourier transformer 511, a channel estimator 513, a BCH demodulator 515, a BCH decoder 517, an other channel demodulator 519 for demodulating other channels, a base station ID-sector ID mapping table 521, and a sectoral code table 523 and a sectoral scrambling code table 525 defined by Equation 5 and Equation 6.

The base station ID-sector ID mapping table 521 is a table in which the relationship between the base station and sector IDs allocated to the corresponding base station is defined. The base station ID-sector ID mapping table 521 shows the sector IDs allocated to the base station. When the base station uses a single sector, it is shown that the remaining sector IDs are not used.

The mobile station 200 shares information on the SCH scrambling code, uₛ, C_{k,t,a,s}, and the sector or cell-specific scrambling code with the base station 100.

FIG. 17 is a flowchart showing a method of receiving a signal according to an exemplary embodiment of the present invention.

First, the down transformer 503 transforms a downlink signal received through the antenna 501 into a baseband signal and outputs the transformed baseband signal (Step S301).

The SCH/BCH band filter 505 filters the baseband signal output from the down transformer 503 and outputs an SCH-band signal and a BCH-band signal (Step S303).

The cell searcher 507 confirms the home sector and one or more target sectors through the SCH-band signal output from the SCH/BCH band filter 505 (Step S305). To this end, the cell searcher 507 acquires symbol synchronization, frequency synchronization, and frame synchronization through an initial cell search, and estimates the sector IDs (identifier). The cell searcher 507 estimates the sector IDs and regards a sector having the largest estimated correlation value as the home sector. Further, the cell searcher 507 recognizes one or more candidate sectors having an estimated correlation value of a predefined threshold value or more. The cell searcher 507 regards a sector of the base station in which the mobile station 200 is located as the target sector, among the one or more candidate sectors with reference to the base station ID-sector ID mapping table 521.

The guard interval remover 509 removes the guard interval, such as a CP, from the SCH-band signal and the BCH-band signal (Step S307).

The Fourier transformer 511 performs fast Fourier transform (FFT) on the SCH-band signal and the BCH-band signal, from which the guard interval is removed, and generates and outputs a plurality of SCH reception symbols and a plurality of BCH reception symbols transmitted along with a plurality of subcarriers (Step S309).

The SCH reception symbol that is transmitted to a specific receiving antenna of a subcarrier k output from the Fourier transformer 511 is represented by Equation 7.

$${ϒ}_{k , t} = {\sum }_{s = 1}^{ζ} ( {H}_{k , t , a , s} \cdot {A}_{k , s} ) + {n}_{k , t} \\ = {\sum }_{s = 1}^{ζ} ( {H}_{k , t , a , s} \cdot {μ}_{s} \cdot {a}_{k , s} ) + {n}_{k , t} \qquad ( Equation 7 )$$

In Equation 7, n_{k,t} denotes additive Gaussian noise, H_{k,t,a,s} denotes a fading channel status of a synchronization channel corresponding to the sector s, subcarrier k, transmitting antenna a, and specific subframe t, and ξ denotes the number of sectors that affect the mobile station 200. For example, when ξ=2, the sector s (=1) is the home sector and the sector s (=2) is the target sector.

The BCH reception symbol R_{k,t} of the subcarrier k output from the Fourier transformer 511 is represented by Equation 8.

$${R}_{k , t} = {\sum }_{s = 1}^{ζ} ( {H}_{k , t , a , s}^{′} \cdot {B}_{k , t , a , s} ) + {n}_{k , t}^{′} \\ = {\sum }_{s = 1}^{ζ} ( {μ}_{s} \cdot {C}_{k , t , a , s} \cdot {H}_{k , t , a , s}^{′} \cdot {p}_{k , t , s} \cdot {d}_{k , t} ) + {n}_{k , t}^{′} \qquad ( Equation 8 )$$

In Equation 8, n_{k,t}′ denotes additive Gaussian noise, and H′_{k,t,a,s} denotes a fading channel status of a broadcast channel corresponding to the sector s, subcarrier k, transmitting antenna a, and subframe t. Further, p_{k,t,s} denotes a scrambling code that is applied to the sector s, subcarrier k, and subframe t by the scramblers 343, 443a, and 443b.

The SCH symbol and the BCH symbol, which are on a time axis adjacent to each other, are transmitted through the same antenna for the same time. Accordingly, the fading channel status of the synchronization channel and the fading channel status of the broadcast channel satisfy Equation 9.

H_{k,t,a,s}=H′_{k,t,a,s} (Equation 9)

Therefore, the mobile station 200 can estimate the fading channel status of the synchronization channel, and apply information on the estimated fading channel status of the synchronization channel to Equation 8 so as to perform coherent demodulation, thereby estimating the BCH symbol d_{k,t}.

The channel estimator 513 estimates the synchronization channel status H_{k,t,a,s} of the home sector and the target sector using the SCH reception symbol output from the Fourier transformer 511 (Step S311). Specifically, the channel estimator 513 multiplies the SCH reception symbol output from the Fourier transformer 511 by the conjugate of the SCH scrambling code, as represented by Equation 10, in order to calculate the synchronization channel H_{k,t,a,1} of the sector 1.

γ_{k,t}×a*_{k,1}×μ*₁ (Equation 10)

Next, the channel estimator 513 performs frequency domain filtering, such as hamming filtering, on Equation 10, and performs inverse fast Fourier transform to generate a time-domain signal. Then, the channel estimator 513 performs gating to reduce an interference signal component and a noise component of the generated time-domain signal, thereby leaving a specific time domain but zeroizing the remaining domains. The channel estimator 513 performs fast Fourier transform (FFT) on the gated signal, and performs inverse frequency domain filtering to calculate the estimate Ĥ_{k,1} of the synchronization channel status H_{k,1} of the sector 1. Subsequently, the channel estimator 513 can calculate the estimates of the synchronization channel statuses of the remaining sectors.

The BCH demodulator 515 performs coherent soft-combining demodulation represented by Equation 11 and estimates the BCH symbol (Step S313). That is, the BCH demodulator 515 recognizes the code value C_{k,t,a,s} of the home sector and the target sector and the scrambling code p_{k,t,s} with reference to the sectoral code table 523 and the sectoral scrambling code table 525. Then, the BCH demodulator 515 estimates the BCH symbol d_{k,t} from the BCH reception symbol R_{k,t} of the subcarrier k output from the Fourier transformer 511 using uₛ, C_{k,t,a,s}, p_{k,t,s}, the fading channel status of the synchronization channel of the home sector, and the fading channel status of the synchronization channel of the target sector.

$${\hat{d}}_{k , t} = \frac{{R}_{k , t} \times {( {\sum }_{s = 1}^{ζ} ( {μ}_{s} \cdot {C}_{k , t , a , s} \cdot {\hat{H}}_{k , t , a , s} \cdot {p}_{k , t , s} ) )}^{*}}{{\vert {\sum }_{s = 1}^{ζ} ( {μ}_{s} \cdot {C}_{k , t , a , s} \cdot {\hat{H}}_{k , t , a , s} \cdot {p}_{k , t , s} ) \vert}^{2}} \qquad ( Equation 11 )$$

When the mobile station 200 does not acquire the target sector ID, the BCH demodulator 515 estimates the BCH symbol d_{k,t} from the BCH reception symbol R_{k,t} of the subcarrier k output from the Fourier transformer 511 using uₛ, C_{k,t,a,s}, p_{k,t,s}, and the synchronization channel status of the home sector.

The BCH decoder 517 performs decoding, such as Viterbi decoding, on a plurality of BCH symbols output from the BCH demodulator 515, and generates BCH information (Step S315).

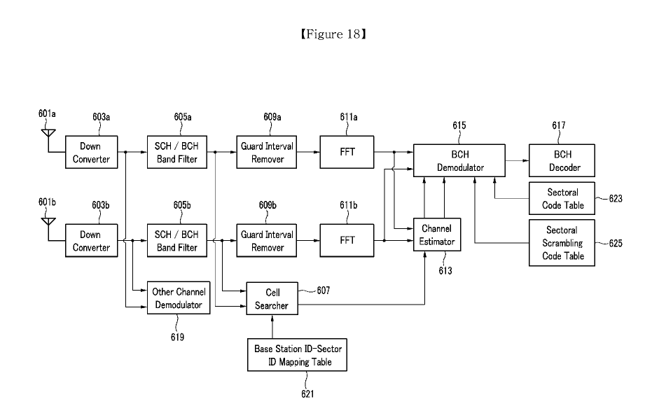

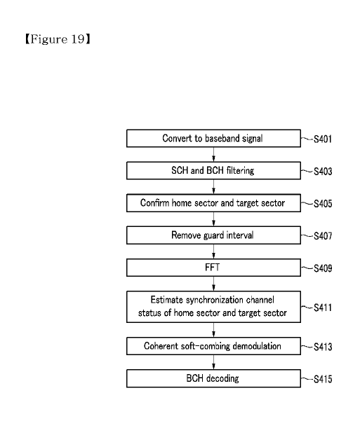

Next, a signal receiving apparatus of the mobile station 200 according to another exemplary embodiment of the present invention will be described with reference to FIGS. 18 and 19.

In the description of FIGS. 18 and 19, the same contents as those of FIGS. 16 and 17 will be omitted.

FIG. 18 is a block diagram showing a signal receiving apparatus according to another exemplary embodiment of the present invention.

As shown in FIG. 18, a signal receiving apparatus 600 according to another exemplary embodiment of the present invention includes a first antenna 601a, a second antenna 601b, a first down transformer 603a, a second down transformer 603b, a first SCH/BCH band filter 605a, a second SCH/BCH band filter 605b, a cell searcher 607, a first guard interval remover 609a, a second guard interval remover 609b, a first Fourier transformer 611a, a second Fourier transformer 611b, a channel estimator 613, a BCH demodulator 615, a BCH decoder 617, an other channel demodulator 619 for demodulating other channels, a base station ID-sector ID mapping table 621, a sectoral code table 623, and a sectoral scrambling code table 625.

FIG. 19 is a flowchart showing a method of receiving a signal according to another exemplary embodiment of the present invention.

First, the first down transformer 603a and the second down transformer 603b transform downlink signals received through the first antenna 601a and the second antenna 601b into baseband signals, and output the transformed baseband signals (Step S401).

The first SCH/BCH band filter 605a and the second SCH/BCH band filter 605b filter the baseband signals output from the first down transformer 603a and the second down transformer 603b, and output an SCH-band signal and a BCH-band signal, respectively (Step S403).

The cell searcher 507 confirms the home sector and one or more target sectors through the SCH-band signals output from the first SCH/BCH band filter 605a and the second SCH/BCH band filter 605b (Step S405).

The first guard interval remover 609a and the second guard interval remover 609b remove the guard interval, such as a CP, from the SCH-band signal and the BCH-band signal output from the first SCH/BCH band filter 605a and the second SCH/BCH band filter 605b (Step S407).

The first Fourier transformer 611a and the second Fourier transformer 611b perform fast Fourier transform (FFT) on the SCH-band signal and the BCH-band signal, from which the guard interval is removed, output from the first guard interval remover 609a and the second guard interval remover 609b, and generate and output a plurality of SCH reception symbols and a plurality of BCH reception symbols transmitted along with a plurality of subcarriers (Step S409). The SCH reception symbol of the subcarrier k can be represented by Equation 7, and the BCH reception symbol of the subcarrier k can be represented by Equation 8.

The channel estimator 613 estimates the synchronization channel status H_{k,t,a,s} for the first antenna 601a using the SCH reception symbol output from the first Fourier transformer 611a, and estimates the synchronization channel status H_{k,t,a,s} for the second antenna 601b using the SCH reception symbol output from the second Fourier transformer 611b (Step S411).

The BCH demodulator 615 recognizes the code value C_{k,t,a,s} of the home sector and the target sector and the scrambling code p_{k,t,s} with reference to the sectoral code table 623 and the sectoral scrambling code table 625. Then, the BCH demodulator 615 estimates the BCH symbol d_{k,t} from the BCH reception symbol R_{k,t} of the subcarrier k received through the first antenna 601a using uₛ, C_{k,t,a,s}, P_{k,t,s}, the synchronization channel status of the home sector at the first antenna 601a, and the synchronization channel status of the target sector at the first antenna 601a. Further, the BCH demodulator 615 estimates the BCH symbol d_{k,t} from the BCH reception symbol R_{k,t} of the subcarrier k received from the second antenna 601b using uₛ, C_{k,t,a,s}, p_{k,t,s}, the synchronization channel status of the home sector at the second antenna 601b, and the synchronization channel status of the target sector at the second antenna 601b. The BCH demodulator 615 combines the BCH symbol d_{k,t} received from the first antenna 601a and the BCH symbol d_{k,t} received from the second antenna 601b to generate a combined BCH symbol, and outputs the combined BCH symbol (Step S413).

The BCH decoder 617 performs decoding, such as Viterbi decoding, on a plurality of combined BCH symbols output from the BCH demodulator 615, and generates BCH information (Step S415).

According to the exemplary embodiment of the present invention, since the BCH bandwidth and the SCH bandwidth are the same, the mobile station does not need to perform blind detection of the BCH bandwidth.

According to the exemplary embodiment of the present invention, the base station locates the BCH and the SCH to be on a time axis adjacent to each other, and applies the same transmission diversity to the temporally adjacent BCH and SCH. Therefore, the mobile station does not need to perform blind detection on the number of transmitting antennas to demodulate the BCH information.

In addition, the mobile station estimates the channel status for a plurality of sectors using the SCH and coherently demodulates the BCH. Therefore, the demodulation performance of the BCH can be improved. Further, it is not necessary to allocate an additional pilot symbol.

The exemplary embodiment of the present invention described above is not only implemented by the method and apparatus, but it may be implemented by a program for executing the functions corresponding to the configuration of the exemplary embodiment of the present invention or a recording medium having recorded thereon the program. These implementations can be realized by the ordinary skilled person in the art from the description of the above-described exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method of transmitting a signal, the method comprising:
mapping a plurality of synchronization channel symbols and a plurality of broadcast channel symbols to a downlink frame to be on a time axis adjacent to each other; and
transmitting the downlink frame.

2. The method of claim 1, wherein the mapping to the downlink frame comprises
allocating a first bandwidth to the plurality of synchronization channel symbols; and
allocating the first bandwidth to the plurality of broadcast channel symbols.

3. The method of claim 1, further comprising:
allocating a first antenna to each of the plurality of synchronization channel symbols; and
allocating the first antenna to broadcast channel symbols that are on the time axis adjacent to each of the plurality of synchronization channel symbols.

4. The method of claim 1, further comprising:
allocating a plurality of antennas to the plurality of synchronization channel symbols; and
allocating the antennas which are allocated to each of the plurality of synchronization channel symbols, to broadcast channel symbols that are on the time axis adjacent to each of the plurality of synchronization channel symbols.

5. A method of transmitting a signal, the method comprising:
allocating a plurality of time intervals to a plurality of synchronization channel symbol groups;
allocating a plurality of adjacent time intervals that are on a time axis adjacent to each of the plurality of time intervals to a plurality of broadcast channel symbol groups; and
transmitting the plurality of synchronization channel symbol groups and the plurality of broadcast channel symbol groups.

6. The method of claim 5, further comprising:
allocating a plurality of antennas to the plurality of time intervals; and
allocating the plurality of antennas to the plurality of adjacent time intervals such that an antenna allocated to each of the plurality of time intervals and an antenna allocated to the adjacent time intervals of each of the plurality of time intervals are the same.

7. A method of receiving a signal, the method comprising:
receiving a synchronization channel signal;
estimating a plurality of channel statuses for a plurality of sectors from the synchronization channel signal;
receiving a broadcast channel signal having information common to sectors in the same base station; and
acquiring broadcast channel information from the broadcast channel signal using the plurality of channel statuses.

8. A method of receiving a signal that allows a mobile station to receive a signal from a base station, which controls a plurality of sectors, the method comprising:
receiving a downlink signal;
extracting a synchronization channel signal from the downlink signal;
extracting a broadcast channel signal from the downlink signal;
confirming at least one sector, which affects the mobile station, among the plurality of sectors from the synchronization channel signal;
estimating a channel status for at least one sector from the synchronization channel signal; and
demodulating the broadcast channel signal using the channel status for at least one sector.

9. The method of claim 8, wherein the demodulating of the broadcast channel signal includes demodulating the broadcast channel signal using a code value for at least one sector and a scrambling code for at least one sector.
